(19) United States
(12) Patent Application Publication
(10) Pub. No.: US 2014/0229243 A1
(43) Pub. Date: Aug. 14, 2014

(54) HAPPINESS-INNOVATION MATRIX (HIM) MODEL FOR ANALYZING / CREATING PRODUCT SOLUTIONS FOR ATTRACTIVENESS AND SUSTAINABILITY

(71) Applicant: Devendra Pal Singh, (US)

(72) Inventor: Devendra Pal Singh, Singapore (SG)

(21) Appl. No.: 14/348,314

(22) PCT Filed: Sep. 28, 2012
(86) PCT No.: PCT/SG2012/000360

§ 371 Date: Mar. 28, 2014

(30) Foreign Application Priority Data
Sep. 28, 2011 (SG) 201107029-9

(51) Int. Cl. G06Q 10/06

(52) U.S. Cl. CPC G06Q 10/0637
USPC 705/7.36

(57) ABSTRACT

Happiness-Innovation Matrix” model focuses on measuring “Happiness Index” and is used to strategize and formulate, analyze and calculate product's overall attractiveness and its (also firm's) sustainability, compared to other products in the market place. It can be represented in different variations for different applications, some examples being Strategic Attack Map (SAM), Consumer Needs Map (CNM), Social stability Map (SSM). It measures both the strategic impact of utilizing four levers of innovations and interactions among them and the role of five circles of happiness, in “providing happiness” to stakeholders in real and virtual world. 4 components constituting “wholesome product experience” being product projecting persona as well as a means for delivery of information/product for consumption; infrastructure to backup and enhance “Wholesome product experience” and Virtual/Real Space for Social bonding & trustworthy knowledge/problem resolution and interaction and finally financial innovation. Five circle of happiness cover “Value Creators” and “network externality” influence encompassing all 4 components.

### INTRODUCTION

Uniqueness of our approach: It addresses the following three pertinent complex questions:
1. What is the current source of sustainable competitive advantage: Paradigm shift has left firms and nations to uncover the new factors for sustainable competitive advantage in current context. Dispersed technological advances has enabled different suppliers to offer different technological options for similar product functionalities; proliferation of expertise and manufacturing excellence together with widely available contract manufacturing from China has undermined competitive edge achieved by conventional product creation, manufacturing and physical infrastructure. Firm's ability to leverage on its conventional innovations such as inclusion of advanced technologies in products, manufacturing processes and conventional infrastructure innovations to efficiently and seamlessly deliver goods have become a prerequisite to enter the competitive arena. Increasingly these conventional routes of innovations are utilized in conjunction with four factors of interactions to achieve sustainable competitive advantage (explained later in detail).

The proposed model captures the essence of Design and systems' thinking and focuses on stakeholders compared to earlier focus on firm, its manufacturing excellence and its ability to leverage on its supplier base, covered by models such as Porter's five forces and Value chain analysis. It shows on how sustainability can be achieved by providing (emotional and logical) happiness to consumers, by utilizing the prevailing complexities and advantages offered by product interactions, new opportunities offered by digital infrastructure and by taking advantage of emerging consumers concerns and trends on ethical behavior, care for environment and emergence of social networking etc. This model helps explain the future progression and predict on what lies beyond the emergence of “Face-book”, things to come along on on-line gaming and reasons for enormous success achieved by Apple's i-store beyond expectation.
2. How to measure and improve effectiveness of innovations for sustainable competitive advantage:

Current measurement tools for innovation process are ineffective as they do not help firms to become more competitive. Innovation is measured by input matrices such as spending on R&D etc or output matrices such as revenue generated by products introduced in last 3 years etc. Both of these techniques suffer as money input in R&D does not directly relate either to R&D success rate or give indication of R&D result's conversion in innovation and revenue generation. As revenue generated is done at the end of the process, it cannot be used to control the innovation process itself. Proposed model leads to focused innovation by enabling options selection by pinpointing different value generating options (in terms of emotional and logical happiness creating options) coupled with means to achieve it. It enables firms to do analyses on how to leverage on “interactions” within and among “supply side's” four new leveraging factors of digitalization, assisted by conventional innovations based on technological advances, physical infrastructure (to include manufacturing excellence, distribution channels, legislation for fair trading and IPR etc.).
3. Predictions and awareness of disruptive market trends: Future direction of industry's offerings can be predicted by utilizing current industry status, including knowledge about industry's progression on “Various innovation stages of product/solutions”, as predicted by Abernathy-Clark and revised models¹ and current technological advances in industry. Being focused on NHI value, rather than on technological solutions alone, this model is able to capture market disruptive (technologically different) solutions offered by other firms thus enabling firm to understand the rationale for disruption as well as formulate fluid strategy in fast moving globalised world, heavily populated by small innovative firms whose market disruptive moves/actions remain unnoticeable. Furthermore this model can help formulate disruptive market moves, based on knowledge obtained from previous market disruptive examples occurred during the earlier innovations cycles within other industries.

Predictions are made robust by utilizing the relevant crucial dispersed and diffused knowledge, available from participation and knowledge base of firm's new interconnected networked environment consisting of internal stakeholders as well as its partners located beyond firm's own well defined boundary. This framework helps focus on scouting relevant information sources (including from front line managers of various networked organizations), gives different weightage to different information and utilizes the desperate individual's partial knowledge as input to produce a composite picture of the business scenario, such as dealing with the details of effect of various factors on individual firm as well on industry, competitor's current positions and prediction of their likely future moves etc.
4. By creating a central theme of achieving happiness, innate requirement of human being, this model is broad based to cover all possible offers (and not just confined to staged events as in Experience Economy) from a firm and includes product, service, experience, solution, transformational, social networking, knowledge creation or a combination thereof (hereafter is called product/services).
5. By creating a comprehensive systems thinking model, it lays the foundation for wider economic road map development mode for nation's future investments as well as for analyzing current gaps which may prove impediments to nation's development. It shows the emerging power of democratization such as emergence of tertiary players such as Blackburry phones which enable ordinary citizens to relay messages to a user group (paralleling police's own network); country's competitiveness as per digital infrastructure, governance, laws and presence of stakeholders etc.

### CURRENT STATE OF ART

In an era dominated by easily available myriad of technological innovations, technological and manufacturing excellence (making product faster, cheaper and with zero defect rate) and outsourced contract manufacturing has become entry level requirement for the market place and thus do not offer sustainable competitive advantage. Product proliferation has created a demand side consumer centric competition (opposed to supply side manufacturing centric competition) and focus is on providing/delivering higher value product/service/experience/solutions to customers than competitors. Broadly two approaches are taken to win over the consumer.

The first approach, creating “high value for consumers”, works by avoiding head on competition. It creates value by focusing on things often overlooked by competitors (Chan Kim and Mauborgne—1997, 99, 2002 and 2005)². It utilizes two sets of “value creation” efforts, viz. it focuses on six utility levers which focuses on increasing product value to customer as improving his productivity, offering simplicity, convenience, risk, fun and image and environmental friendliness etc. Similarly other set based on, six buyer experience stages which are associated with product ownership, focus on value created by the product over its entire life time on consumer, ranging from purchase, delivery, use, supplements, maintenance and disposal. This value curve compares the competitive offerings from various suppliers. This approach provides a useful way to create value as compared to head on competition where perceived value to customers shows the existence of sloping curve towards the (compression at) higher price level, as shown by “Cost Quality frontier”, thus indicating that perceived quality does not rise proportionately with price (Saloner et al 2001)³. Approach based on value creation is also utilized by “Beyond the Core (Products)”⁴, whereby solutions for customers are created by making adjacency move in a related areas such as by creating new product lines or by forming new channels of distribution. This move takes firm away from its core business and offers limited short term competitive advantage.

The second approach focuses on experience created for customers in “Service” sector and it yields substantial dividends as compared to just providing the product (Pine and Gilmore)⁵. In their book “Experience economy” (and later Fantasy Economy), authors narrowly focused on service industry's examples, staged event by the provider, and look on how the experience undergone by recipient while participating in staged event, provides the competitive advantage. Recently “design centric product development” thinking is gaining the momentum, yet the direction is not clear. Firms are still grappling with new paradigm of competitive game. Above discussed approaches so far focus merely on customer's needs on superficial level thus forgoing a holistic approach.

### DESCRIPTION OF INVENTION

Proposed model reflects the current unfolding of “Happiness Revolution”, associated paradigm shift for achieving sustainable competitive advantage via providing specific happiness to firm's various stakeholders, as represented by five circles of happiness, rather than by manufacturing excellence. Firm offer/create these circles of happiness by utilizing four innovations, i.e. interaction within and among “three interaction innovations of supply side” and financial innovation.

### A. Creating Five Circles of Happiness:

In today's changed scenario, firms achieves sustainability by providing happiness, by way of creating/focusing on different circles of happiness (shown in FIG. 1 as concentric circles, to new era stakeholders viz. customers, knowledge workers (employees), co-opetitors, 3^{rd} party vendors (contract manufacturers, outsourced R&D, component suppliers, distribution channels), and venture capitalist. First circle of happiness focuses on customer's happiness, ultimate being the inner peace, i.e. ability to live peacefully with oneself, by helping those transforms their life. 2^{nd} circle of happiness focuses on providing its knowledge workers “Hope to fulfil desire of succeeding and realizing their full potential” by creating conducive, positively charged workplace environment with buzz of top leadership, so that they scout unique opportunities by utilizing their contacts (wisdom of crowd), efficiently utilize firm's internal and external resources to create unique value proposition. 3^{rd} circle of happiness focuses on establishing an “open platform” operating at primary level, thereby providing incentives to players of two subsequent levels of 4^{th} and 5^{th} to freely participate in it and become more efficient. 4^{th} circle of happiness focuses on establishing “closed platform” while encouraging establishment of 5^{th} circle of “controlled democratization” (closely controlled Apple Apps-store). Thus firm taking the 4^{th} level of happiness approach gives happiness to its customers by creating multifunctional, seamless operating product family while keeping all of its products under tight control. 5^{th} Circle of happiness is populated by firms representing democratization process—whereby it empowers individual vendors, be it Applications (Apps) developers, individual user firms Iris (Singapore bus information i-phone app), mobile dating firm in Japan, local corner shop in remote Indian village (acting as a bank for EKO India Financial Services).This democratization process enables firm's venture capitalist, provider of smart money, to efficiently utilize their network and knowledge thus helping him progress professionally yet at the same time create value for the firm with their relative long term investment as compared to shareholders money (where investment could be matter of minutes) focused on extraction of money from value created by the firm's management and employees.

B. Leveraging on Four Innovations: It deals with the question on how firm creates above stated circles of happiness. Firm utilizes interaction within and among “three interaction innovations of supply side” (as represented by 3 regions of influence in FIG. 1.) together with financial innovation to provide above stated benefits to stakeholders. Firm leverages on interactions (compatibility) within and among digital products with creation of searchable digital format of voice, data and image thus enabling data mining; leverages on digital infrastructure, sometimes in combination with physical infrastructure, to achieve unique consumer accessibility with respect to time, venue and demand; leverages on its ability to provide access to knowledge base/exclusive society, with higher level of inner happiness. Firms utilize financial innovations to enhance stakeholder's value: leveraging on web-advertisement revenue, subsidizing product's price thus improving value proposition to consumers; by giving share options to its knowledge workers; by opening up its marketing channel to 3^{rd} party suppliers (Apple's Apps-store with both Apple and suppliers sharing the profit) or allowing co-opetitors (sharing drug sales licenses) to profit sharing; and by giving Venture Capitalist the opportunity to invest money during 2^{nd} and 3^{rd} round of financing.

### DETAILED WORKINGS OF THE PROPOSED MODEL

Following discussions details, gives workings and rationale on how effective “five circles of happiness” are created by utilizing 4 innovations effectively.
A. Five Circles of Happiness: It focuses on the question of how “providing happiness to stakeholders ensures product's success and attractiveness to customers and results in its mass adoption, such as adoption of operating system, 3^{rd} party apps (Skype) etc.
   a. Customer's Happiness: First circle of happiness (shown as centre core in FIG. 1), focuses on consumers to maximize their “own happiness” (Net Happiness Index (NHI)), by way of fulfilling both short term and long term needs. It provides long term happiness by fulfilling consumer's specific needs, ultimate being the inner peace, i.e. ability to live peacefully with oneself; fulfilling innate needs focused on creating meaningful change, which provides longer lasting happiness and leads to customers' loyalty. It fulfills short term happiness by fulfilling explicit expressed need which attracts customers to buy the product. Satisfying both needs is required for product's success, as can be seen from analogy of creating a long term relationship; role played by short term attraction (satisfying expressed need) in the process of falling in love (short term) is as important as to get the chemistry of initial love going (attracting the customer to buy the product) but it is caring and sharing attribute (satisfying innate needs by products and bringing the change in customer) which keeps the development of long lasting relationship of marriage going (customer loyalty). Focus on providing long term happiness should be firm's goal as it leads to firm's sustainability. As product acts as “an enabler of long term change, it wins in the market place as longer lasting happiness outlast the product itself (friendship with Obama after expiry of Vertue contract), thus creating long term product loyalty. Current focus on long term happiness is a definite move away from earlier focus on Brand name consumerism which, in words of Geoffrey Miller⁶ (May 2009), ”created wrong priorities in peoples life and “it (was) not good at getting us to feel happy”.

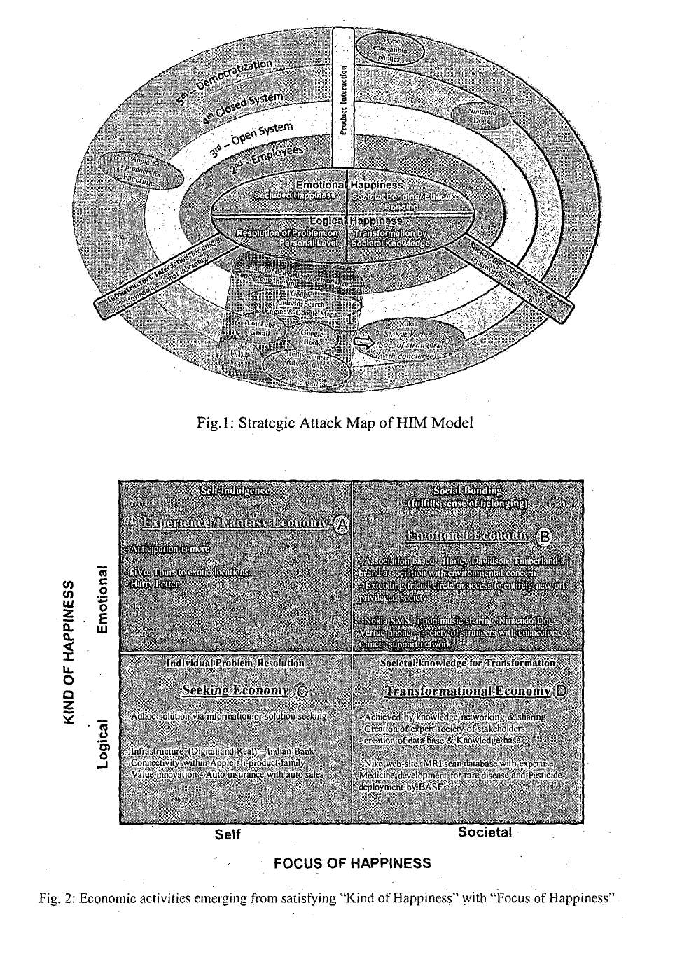

Firm can focus on satisfying consumer's emotional or logical happiness (kind of happiness) which may be concentrated on their own or on society (focus of happiness) as shown in FIG. 2. As shown in FIGS. 1 and 2, firms are helping its consumers fulfill their quest for maximizing their own “personal happiness” which leads to emergence of different economic activities. Firm may choose to create a product/solution focused on one or more economies given below.
1. Experience/Fantasy Economy: Firm create product/applications which helps self-indulgent consumer to amuse himself or achieve inner peace via inner satisfaction, such as by providing TV watching experience—TiVo (experience economy) or helping in indulging in a fantasy (Fantasy Economy). It is quite powerful as happiness achieved from anticipation is even larger. (FIG. 2)
2. Emotional Economy: Firm create product/applications which helps consumers to maximize love and affection, e.g. by giving them opportunity to participate in a society or by providing sense of belonging (Love and affection) by creating a societal bond. It satisfies consumer's urge to do things to get love and affection from others such as by leveraging on sense of belonging to morally upright group or association based (Ethical issue in case of Timberland shoes and its environmental concern (discussed later), by extending consumer's friend circle (Nokia SMS discussed later) or by giving access to entirely new/restricted society thus fulfilling consumer's desire for sense of belonging.
3. Seeking Economy: Firm creates product/applications which provide consumers with information to resolve the problem. This leads to fear minimization, or mitigation of his personal risk factors.
4. Transformational Economy: Firm creates product/applications which provide consumers with information to resolve the problem. This leads to fear minimization, or mitigation of his personal risk factors, by utilizing societal data bank, sharing knowledge and creating an expertise to transform him.
b. Employee's Happiness: 2^{nd} circle of happiness focuses on firm's efforts to provide its knowledge workers with “Hope to fulfil their desire to succeed and realise their full potential” by creating conducive, positively charged workplace environment with buzz of top leadership, so that they scout unique opportunities (wisdom of crowd), efficiently utilize firm's internal and external resources to create unique value proposition. Firm also nurtures its employees to behave in ethical manner as employees' reputation become synonymous with firm's brand name with today's media savvy consumers. Bad publicity, e.g. unethical treatment of 3^{rd} tier suppliers by employees becomes brand liability.

### OUTSIDE FIRM'S BOUNDARY

Firms have developed sustainability by creating a process of enabling participation by 3^{rd} party suppliers (contract manufacturers, outsourced R&D, component suppliers, distribution channels), co-opetitors and other value creating participating individuals to become firm's partners in its competitive battle, by helping firm to succeed while reaping the benefits of privileged group's success. Firm can provide happiness to 3^{rd} party suppliers by utilizing opportunity offered by 3^{rd}, 4^{th} and 5^{th} circle of happiness. By treating its 3^{rd} party supplier base, providing the opportunities to prosper intellectually thus fulfilling aspiration of entrepreneurship, and thus creating a powerful ally for competitive battle; by ethically treating them and thus creating goodwill for the firm in industry and thereby attracting ethical consumers; enabling its venture capitalist, provider of smart money, to efficiently utilize his network and knowledge thus helping them progress professionally. Smart money (relative long term investment) from Venture capitalists helps the firm grow compared to shareholders money (could be matter of minutes) focused on extraction of money from value created by the firm. Thus firm has following competitive processes options available to enhance its competitive position.
c. Stakeholder's happiness for Open Platform: 3^{rd} circle of happiness is focused on firm's effort to establish itself as de-facto provider of “open platform” operating at primary level, by providing incentives to players of subsequent two levels. In an effort to make itself as a de-facto platform to provide infrastructure, Open platform provider (e.g. Google) let other businesses use its platform (Android operating system, Google map and Search engine) thus making them more efficient (using Google's search functions make their web-site searchable). On the other side, it enables the 3^{rd} party suppliers (from 4^{th} and 5^{th} circle) the freedom to offer their services without a central control (Apple can use Google map), thus enabling mass adoption. Successful example includes Android operating system where wisdom of crowd has prevailed and resulted in its Apps (applications) number far exceeding that of Apple. Controlling the infrastructure gives unprecedented power as Similarly, Special disease management sites enable democratization by its participants—it gives its members viz. patients, doctors, healthcare providers, and experts' etc. access to specialist venue where they can participate in a meaningful way thereby becoming more efficient.
d. Stakeholder's happiness for Closed Platform: 4^{th} circle of happiness focuses on provider of “closed platform” operating at secondary level thus enabling the participation of democratized society from 5^{th} circle of happiness. In this firm makes/keeps all of its products under tight control (Apple interacting products and its operating system) yet offer its consumers of free choice of applications (Apple Apps-store). This gives the legitimacy and confidence to customers for the 5^{th} circle suppliers. Another example is Groupon, which provides legitimacy to various offers made by unknown suppliers thus enabling consumers to take up the offers such as tour offer of holiday package. TiVo with its database for matched TV viewing and SK-II product family for skin refinement are typical examples of closed system platform where consumer's database remains with the firm and if he leaves the firm, all the progress made to date is lost for ever. This in turn gives firm sustainability by consumer retention. Similarly E-bay with its wise-men program attracts businesses using e-bay, binding both wise men as well as businesses to E-bay as both of them now know each other and if they decide to leave e-bay, their reputation/business will suffer. Nintendo dogs is yet another good example whereby two Nintendo game counsels with Dog application imitates noise of dog barking when two of its owner are in nearby location, thereby giving them the opportunity for social interaction with each other. In this case, friendship will last longer than the possession of Nintendo Dogs, as it helps recognise a common interest between two strangers.
e. Democratization and Happiness: 5^{th} circle of happiness represents opportunity to provide happiness to the participants of democratization process which is enabled by digitalization. Democratization is the empowerment leashed by the pervasive interne and mobile phone's ability to transport digital information (image, voice data). Firms provide happiness by empowering its 3^{rd} party supplier base, independent applications developers (small or large such as Skype), and venture capitalists. As it relies on wisdom of crowd, it defines the success of the firm. It empowers its 3^{rd} party supplier base by ethically treating them, providing them the opportunities to prosper intellectually fulfilling their aspiration for entrepreneurship, which in turn creates a powerful ally for its competitive battle. Democratization results in empowerment—conceptual move from Encyclopedia Britannica (where contents are controlled by publishers) to emergence of Wikipedia—result of democratization. Democratization process is empowered by large firms underwriting genuine nature of 3^{rd} party's Apps so that consumers are not cheated (gives power to Apple's Apps-store over Android store; Microsoft's associate program). Treating 3^{rd} level supplier ethically, it creates goodwill for the firm in industry attracting ethical consumers.

Furthermore, firm enables its venture capitalist, provider of smart money, to efficiently utilize his network and knowledge thus helping him progress professionally.

Right of information Act in India has empowered public to gain Government held information by paying a small fees. This in turn has created an atmosphere which will curb nepotism, graft etc.
B. Utilizing Four levers of Supply Side Innovation: This section of model, as shown 3 pillars of influence with financial innovation's superimposing influence, measures the strategic impact of utilizing interactions among and between newly created “four levers of innovations” on product's (and firm's) competitiveness. Firms can utilize “interactions⁷” within and among these newly created four leveraging factors of digitalization as well as use it in conjunction with conventional factors such as physical infrastructure and customer interactions to create, deliver and provide better product/solutions to consumers thus providing happiness.

These levers has resulted from the new capabilities created by digitalization, viz. common digital format for image, voice and data enables the creation of huge amount of data capable of being data mined to create knowledge; lower price for creation and storage of such data, ease of its operation and reduced computing cost has enhanced the value and wide usage of such data. First lever being, Digital Product's capability to interact with other product and ability to create data base capable of becoming intelligent and ability to create the knowledge from the data base. Second lever being, Digital Infrastructure's ability to retain given digital format (Nokia SMS), to provide consumer accessibility thus enabling collection and sending/delivering contents/solutions worldwide. Extremely cheap and widely accessible digital communication around the world coupled with wider participation from population across the globe has further enhanced gathering of data as well as access to data from different places in different formats. This has resulted in creation of well informed and well-connected society, capable of forming niche focused and yet global societies. Third lever to provide/create society for knowledge and Bond creation has emerged which help resolve consumer's problems by utilizing expertise and societal knowledge or fulfills belonging need of consumer by bond creation/participation.

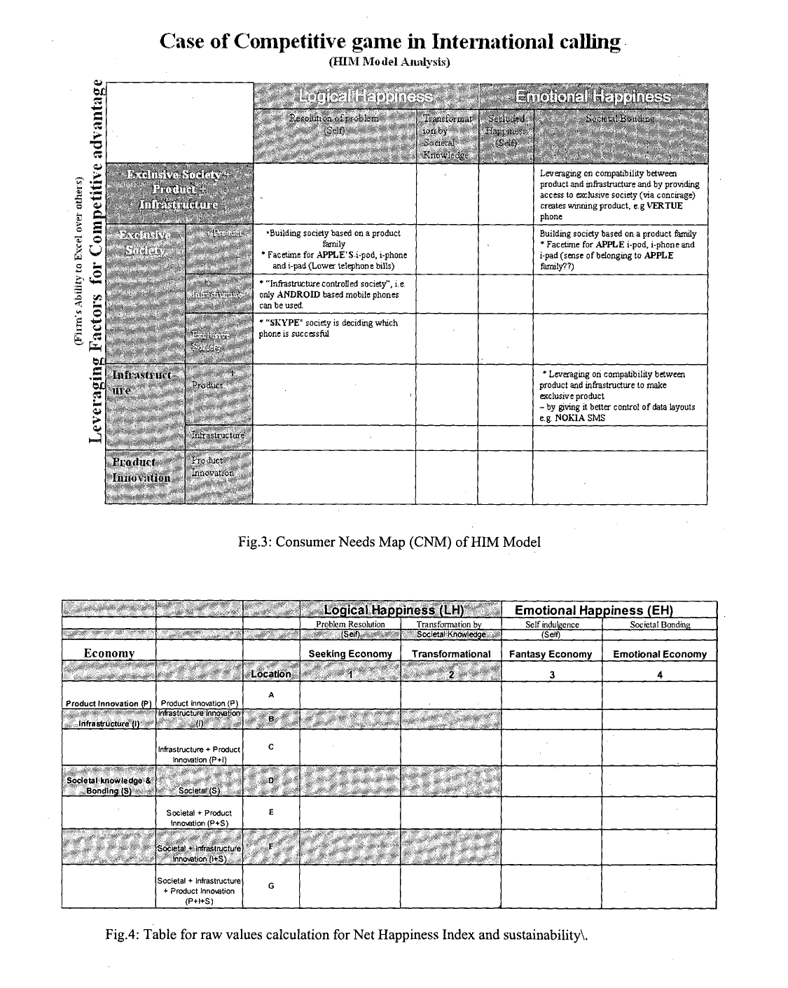

Fourth lever being Financing Innovation which has created a new variable in strategic battle. Firm can utilize product interactions, creating and controlling access to infrastructure or creating and then controlling the participation in a community or ability to advertise while customers are accessing the information to earn money. This in turn has delinked main product pricing from firm's desired profitability. Thus financing innovation improves value proposition of the product offer, by enabling firm to improve “Net Happiness Index” either by enhancing happiness by including other happiness enhancing products/propositions or generating money by controlling the access to a society or by reducing the price, compensated by other revenue generating activities such as advertisement on internet. Excellent examples of financial innovation are seen in Apple and Google. By selling 3^{rd} party supplier's applications in its Apple App store, Apple not only generates substantial sum of money but this also increases i-phone's usefulness. Similarly, Google offers its platform to be used by others (financial innovation) but in return it gains by knowing the latest segmented industry trend (different web-site or minority newspapers attract different consumers). Google's can then use information from g-mail (mental thinking), coupled with these social trends and Google map (Location of a person) to deliver personal taste and location specific information while keeping in tune with the current trend. Face-book and Twitter pose challenge to Google's business model, as chats on these sites capture more of consumer's personal thinking; conversation via “notes on the walls” are a good indicator of the social trend (wisdom of crowd) and consumers are likely to trust someone than from their group more than 1000 search items from Google. Probably this may be the reason for Google's introduction of Google Plus.
C. Creating Happiness-Innovations Matrix Model (HIM Model): HIM model, formed by combining “five circles of happiness” and “four levers of innovations” can be represented by two maps: Consumer Needs Map (CNM) and Strategic Attack Map (SAM). Consumer Needs Map (CNM) shows how a firm positions itself to resolve consumer's emotional and logical needs and therefore measures product's attractiveness to consumer whilst Strategic Attack Map (SAM) deals with reasoning on how firm achieves this competitive advantage and deals with its sustainability, issue.
   a. Consumer Needs Map: It helps firm to understand about product's attractiveness for consumer, in terms of its ability to provide emotional and logical happiness to consumer by utilizing four levers of innovations (FIG. 3). Products are no longer single function but they perform multiple tasks, offering several options to do similar things though consequences of these minor variations can be significant. As consumer want perpetual benefits, by providing opportunity for social bonding or by resolution of a problem firms achieve customer loyalty. Due to differing individual needs, different consumers derive different happiness values from same kind of offering. Thus, e.g. different users of Facebook achieve their happiness by various means: by utilizing its power to bond with peers; by achieving celebrity status amongst their peer group so that they keep viewing their profile and updates; by using Facebook's fear minimization “snooping power” (logical happiness) which helps reduce anxiety and uncertainties for its anxious “teenage consumers” and help them benchmark their own life against peers. Similarly on mobile phone scene, one may like Blackberry's function of keeping him updated with corporate happenings via corporate e-mail system; yet to someone else android phone which can use Skype to call overseas for free would be the better option. It is these small variations that contribute significantly differently to logical or emotional happiness and thus cause big difference in overall happiness value. Probably, it is the reason that phone manufacturers has created store for third party software, giving consumers to maximize their own “Happiness Value”.

Consumer Needs Map focuses on analyzing on how a firm utilizes four levers of innovations to win over consumers by focusing on self or societal happiness achieved by resolving consumer's emotional or logical needs (FIG. 3). It can be used to formulate product offers or analyze competing product offers. Given below is a systematic analysis of how four levers of innovations (alone or in combinations) can be used to provide consumer happiness and covered systematically in FIG. 3.
1. Product Interaction Innovation: It covers the ability to create a product which is, capable of interacting with other products, personalized to specific customer's needs or being “data base intelligent” capable of resolving the problem. Examples of such products include multi-tasking products which leverages on media convergence, multi-point usage products for same applications (ability to continue watching movie on i-phone after watching on i-TV) or an intelligent product formed as a result of leveraging on information/knowledge base (database) created by intermixing of voice, data and image. Typical examples of such products are SK-II product family and TiVo: SK-II product family together with skin analysis and advice gives a safer way to having a radiant skin compared to merely using SK-II magic water which may cause skin dryness; TiVo programming provides individually tailored TV viewing corresponding to consumer's viewing preferences based on data mining and wider consumer's data base.
2. Infrastructure Innovation: Digital infrastructure empowers firms to retain unique data format and enables it to deliver product solutions direct to customers at a specific time and place—when used in combination with physical infrastructure, it gives sustainability to firm's value proposition—such as by creating a network of corner shops in village, EKO India Financial Services is able to create banking facilities at the village level, unsurpassable by big banks. Infrastructure also gives unique consumer accessibility and ability to seamless collect and send/deliver timely profile based consumer information and consumer specific contents/solutions world wide via internet, Wi-Fi hotspots etc. thus adding global leverage to business. Another application based on infrastructure advantage is Google's ability to track customer's movements using its Android operating system/Google Map.
3. Infrastructure and Product Innovation: Leveraging on compatibility between product and infrastructure to make exclusive product—G-talk for Android is typical example of Infrastructure controlled society whereby consumer requiring G-Talk will have to choose Android based phone. Yet another example is offers by Groupon—whereby products are offered by individual unknown travel agents but legitimized by infrastructure provider, Groupon who collects the money and issues vouchers.
4. Societal Innovation for Knowledge and Bonding: Its main aim is to either resolve problem utilizing societal knowledge and expertise or fulfill belonging need by enabling participation in a closed society or bond creation. It enables creation of exclusive place capable of creating an exclusive society, creating a site with specialist knowledge data base or even creating an exclusive socially bonded society sharing knowledge from an excusive database or consisting of knowledge experts.
5. Societal Knowledge & Bonding+Infrastructure: Leveraging on compatibility between Infrastructure and societal knowledge and bonding to make exclusive product—by giving it better control of data layouts (such as in the case of Nokia SMS) or by providing exclusive services by adding physical infrastructure (such as in the case of Vertue where access to exclusive society is provided via Vertue's Concierge world-wide Service). Digital infrastructure empowers firms to retain its own unique data format—Nokia used its modules at telephone exchange to retain unique data format and thus were able to keep the SMS format same between two Nokia phones in 1999-2001 while appearing as garbled message with other phones. Google has just entered this space by creating Google-Book which is based on its gmail, g-talk and video conferencing. Once it attracts substantial number of customers, it can make Apple's i-phone and i-pad useless by not providing the full features to it.
6. Societal Knowledge & Bonding+Product: Leveraging on compatibility between product and societal knowledge and bonding. In simplest form, it creates a product based society such as Skype users get dictated on which phones they can buy, if they want to talk to Skype society members, thus ruling out phones on which Skype cannot be downloaded. Yet another example being Nintendo dogs whereby Nintendo game console enables its owners to tap into the Nintendo society with Dog application on their game console.
7. Societal Knowledge and Bonding (main)+Infrastructure+Product: Leveraging on compatibility between Products, infrastructure and exclusive society to create products which gives access to exclusive social knowledge/bonding. Earlier example of such societal knowledge and bonding is Nike's website for personal data download which utilizes its own broad database of its own customers to advise user regarding their data download. One can think of knowledge networks interacting between themselves and its interaction is supported by a common bond between its owners/members. Such would be probably the ultimate knowledge network built on trust.
8. Financial Innovation: Fourth lever being Financing Innovation which has created a new variable in strategic battle, thus enabling firm to utilize product interactions, creating and controlling access to infrastructure or creating and then controlling the participation in a community or ability to advertise while customers are accessing the information. This in turn has opened up several money earning venues which are different than simply selling the main product thus delinking main product pricing from firm's desired profitability. Thus financing innovation improves value proposition of the product offer, by enabling firm to improve “Net Happiness Index” either by enhancing happiness by including other happiness enhancing products/propositions or generating money by controlling the access to a society or by reducing the price, compensated by other revenue generating activities such as advertisement on internet. The effect of financial innovation on product's attractiveness and sustainability is done by using the “Consumer Needs Model” template.
b. Strategic Attack Map: It deals with reasoning of firm's competitive advantage and most importantly with firm's or product's sustainability. 1^{st} Circle deals with happiness to its consumers and its value is calculated using CNM template for product's attractiveness (as measured by NHI value discussed below) and sustainability. 2^{nd} circle of happiness focuses on activities concerned with providing its knowledge workers “Hope to fulfil desire of succeeding and realizing their full potential” by creating conducive, positively charged workplace environment with buzz of top leadership, so that they scout unique opportunities by utilizing their contacts (wisdom of crowd), efficiently utilize firm's internal and external resources to create unique value proposition. 3^{rd} circle deals with situation whereby firm is the provider of “Open System” and ways it uses to attract third party users to use its “operating system” or platform. Typical example being Google getting 3^{rd} party suppliers to use (based on logical reasoning of getting good results) its Google Map, Google Search engine, Adwords (by putting it as a link in their own web-sites and thus earning revenues from each advertisement click) etc. 4^{th} circle deals with firm offering a “closed system” and ways it uses to attract 3^{rd} party users to use its platform in their own applications. Successful example of this being Microsoft with its Associate program whereby it attracted applications developers to develop software for firms. However same concept was furthered by Apple by creating “Apple Apps store” whereby it sold the applications and shared the revenue with Apps developers. 5^{th} circle deals with democratization process and includes participants such as individual applications providers such as Skype, Android based phones and Adword user web-sites.
c. Calculating product's attractiveness and Sustainability by utilizing SAM and CSM:

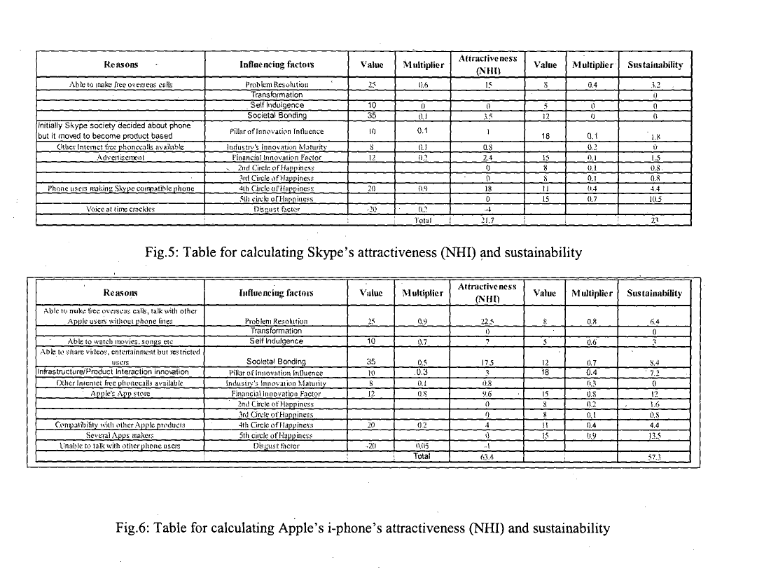

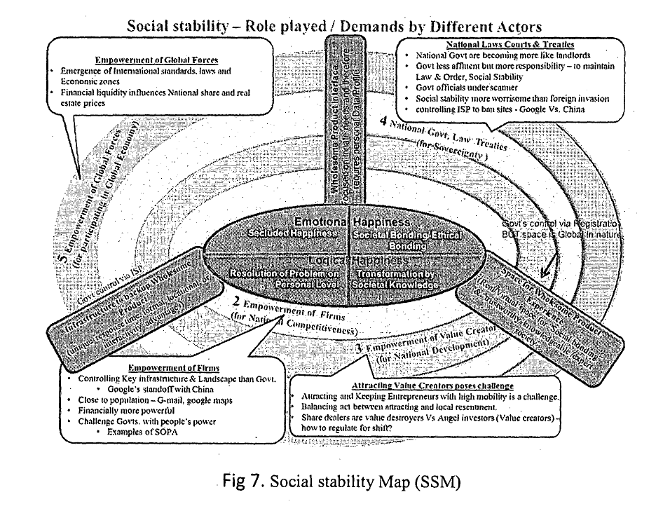

Product's attractiveness relies on how well a product satisfies two kind of happiness, viz. emotional and logical happiness of the consumer which can be achieved by having two kinds of focus, viz. on self (self-indulgence or individual problem resolution) or on society (societal happiness or access to societal knowledge). It is calculated by using Consumer Needs Map's template (FIG. 4) to get the raw values of NHI which is then used in overall calculating table for attractiveness and sustainability (FIG. 5). Net happiness Index reflects product's attractiveness and its main components are Logical Happiness Index (LHI) and Emotional Happiness Index (EHI) minus Disgust Index (DI) generated by the product/service offered. It also takes into consideration of other factors such as industry's innovation maturity etc. (FIGS. 5 and 6). It is important to note that relative importance of emotional Vs logical happiness changes for different applications or different market segment and consequently different “values” are assigned to LHI and EHI when calculating for overall NHI (see FIG. 5 under column “Value”). When comparing two or more firms, multiplier is used to get firm specific number for such values. The dynamic nature of the market place and thus fast changing relative position of various offerings are captured by introducing “Industry's Innovation Maturity” (IIM) in equation for calculating Happiness Index value. It dramatically changes the resulting value of Happiness Index value, reflecting the relative contribution changes over time period of different product/service attributes.

As product is multifunctional and NHI value for same product will differ substantially for different market segment and therefore NHI provides excellent strategic advantage. It can be utilized to create effective customer segmentation (even personalized), by focusing on developing product for dominant requirement for a given set of customers. This is obtained by utilizing firm's dispersed and diffused knowledge/perception of the market place. Thereby NHI can be used to create novel product offers, modify/reformulate existing product solutions or compare competing product offers. NHI value is dynamic reflecting dynamic nature of market requirements, consumer's expectations, technological advances and dynamic stages of the product life cycle. Therefore a comparative NHI value against competitor's offers is time specific and gives an indication of product's current and near future market acceptance, probable market share and thus can be used to formulate products ahead of firm's competitors. NHI helps create a reliable rapid-response fluid strategy deployment system for a firm, by enabling it to respond to unnoticeable subtle moves within industry, as discrepancy between market performance data and relative NHI value will enable a correction to be made for reliability of firm's knowledge sources.

Calculating Firm's Sustainability: Firm's or product's sustainability depends on its ability to provide access to exclusive society for bonding, to specialist knowledge, data base or exclusive choice or infrastructure. As compared to product attractiveness value (NHI), calculating sustainability involves using Strategic Attack Model position and values extensively. To understand the difference between CSM and SAM, e-bay is taken as an example. Looking in “Consumer Needs Map”, e-bay is shown to occupy matrix position which builds on Infrastructure Innovation and problem resolution on Logical Happiness. However, it is the Strategic Attack Map (SAM), which shows the reason for e-bay's sustainability—e-bay is located in 3^{rd} circle of happiness as a firm with open system, its business built on providing the infrastructure to its business partners as well as to its successful society base of value hunters (both located in 5^{th} circle of happiness). However, it has achieved success by making itself a closed system by introducing Wiseman program (present in 4^{th} circle of happiness) thus creating reluctance for both Wiseman as well as business partners to move elsewhere as they have secured special status here. Similarly, looking at the case of Skype and Nintendo Dog applications, both SAM and NCM gives different picture. Both are leveraging on compatibility between product and societal knowledge and bonding. In simplest form, it creates a product based society such as Skype users get dictated on which phones they can buy, if they want to talk to Skype society members, thus ruling out phones on which Skype cannot be downloaded. Yet in case of Nintendo dogs, Nintendo game console enables its owners to tap into the Nintendo society with Dog application on their game console. However, Consumer Needs Map suffers as both Skype and Nintendo Dogs are covered in this category but looking at Strategic Attack Model (SAM), it becomes clear that Skype occupies 4^{th} circle of happiness while Skype occupies 5^{th} circle of happiness. Skype takes up a position closer to “Product Interaction Innovation's pillar of influence” than Nintendo Dogs which occupies a position half way between the “pillar of Product Interaction” and “Society for Social bonding's pillar of influence”. This in turn makes substantial difference in product's sustainability. These values are used in calculating “sustainability” (FIGS. 5 and 6).

Application of Consumer Needs Map: Competitive game in International calling This is based on Logical Happiness—resolution of the problem of how to reduce the cost of international calling? Three methods can be used for making an international call from the mobile phone, viz. expensive national carriers, relatively cheap calling card service or near free VoIP. Increasing availability of both free wi-fi zones and cheap 3G data plans, VoIP is fast becoming a battle ground. Skype, Nokia's leveraging on Skype, Google's G-talk and Apple's “face time” is compared to show how the competitive game is played.

Skype leads the pack with a “product based society” system which builds on half a billon registered users for international/distance calling. Thus mobile Skype user will be able to talk/videoconference to mobile and computer Skype users. Skype users can also make calls to international numbers but they are currently more expensive than G-talk. Nokia is also a player in this game keeping a very low profile—by simply developing phones specifically to be compatible with Skype phone. G-talk, on the other hand is a typical example of “Infrastructure based society” i.e. only android based mobile phones can use this mode and its users can talk to g-mail users on computers. Beside, G-talk users can also make rather cheap international calls to telephones abroad. Apple, on the other hand has unveiled a “Facetime” on all of its i-products which allows free talk between its users of i-pod, i-pad and i-phones, as long as they are in wi-fi zone or i-phone users with 3G data plan.

So what is on stake and who has better chances of winning? Above described complex competitive game becomes easy to analyze by using HIM model. Though both Skype and G-talk are competing through their infrastructure based competencies they occupy different places on HIM model's Strategic Attack Map. Mobile phones which want to tap into Skype user market have to make their phones compatible with Skype (module/application), such as Nokia with several of its models, i-phones as well as android phones, thus making such phones as “Skype compatible phones” or in general participating in “Society based on a Product” (5^{th} circle of happiness). On the other hand, phones utilizing G-talk are typical examples of “Society based on Infrastructure”, i.e. such phones must have Android operating system and would be able to use other Android based facilities as well (3^{rd} circle of happiness). Apple's “Facetime” is built on i-product family, thus creating “Society based on closed system” (4^{th} circle of happiness).

On surface, Skype, due to its 500 million installed bases, appears to be more attractive than both G-talk and Apple's Facetime. However future is bright for both Apple and G-talk as compared to Skype, unless Skype plays on some other competitive strategies and occupies other spaces on the matrix. G-talk appears to be more attractive, given the success of its Android O/S by getting several mobile phones manufacturers on board as well as ability to make cheaper calls to other international phones via cheap G-talk pricing as compared to Skype. Beside, by integrating g-mail and now Google plus with G-talk has ensures that G-talk society will be an active one (populated with friends) as compared to that of Skype, as most of the people will be logged on g-mail as compared to Skype where one logs on when wants to talk. G-talk, being a infrastructure based, can open up in offering several services, such as mobile dating etc, thus making an inevitable winner. Looking at Nokia's positioning, it becomes clear that Nokia could be playing a game of Emotional Economy as against Transformational Economy based on the logical reasoning of reducing the cost of overseas telephone calls, by providing exclusivity (and hence emotional happiness) in an Open Ecosystem such as it did by introducing SMS and Vertue phone. Recent purchase of Skype by Microsoft may change Nokia's game plan.

### CONCLUSION

This model elicits and focuses on crucial and relevant personnel's input at various levels within the organization and thus utilizes organizations' dispersed and diffused knowledge base to generate a timely relevant strategy formulation, resulting in rapid strategic response and positioning of the firm. This framework enables firm to respond rapidly to subtle moves within industry, often unnoticeable at industry level analysis and thereby sustaining its competitive advantage.

Based on systems and design thinking, this model gives a bird's eye view on competitive mode utilized by the leading innovative firms, changing industry trend and structure, kind of innovations and supporting infrastructure required to utilize four new leveraging factors efficiently and consequently achieving sustainability. Three new leveraging factors for innovations act by creating effective interactions amongst and between themselves, i.e. products/society/infrastructure while influenced by technological advances and changed product focus resulting from changed consumer requirements such as ethical behaviour, care for environment and emergence of social networking etc. By combining the effects of these interactions on consumer happiness and relating it to firm's sustainability, this model can be used to uncover capabilities gap impediment to nation's competitive advantage which may be due to missing key factors for effective products/consumers/infrastructure interactions, lack of progress in entrepreneurial firm's efforts in specific areas or national technological deficiencies. This model lays out a foundation for developing a wider economic development model guiding nation's development. Furthermore applicable across various industries, this model may help uncover technological and capabilities gaps for a firm thus guide it for IPR acquisition, give firm direction for the its growth via M&A activities. It can also help start up firms to scout for opportunities in rapidly changing market place. Applicable to KBE, this model is similar to what Porter's 5 forces, value chain were for manufacturing era.

### REFERENCES

¹ Singh Devendra (2001), Bundling Strategies and its inclusion as a third phase in Product/Process Innovation Model, November 2001, NUS working paper, RPS #2001-032 (CMIT).

² W. Chan Kim and Renee Mauborgne {Chan Kim, W. and Mauborgne, R. (2005), Blue Ocean Strategy, Harvard Business School Press; Chan Kim, W. and Mauborgne, R. (2002), Charting Your Company's Future, Harvard Business Review, June 2002.; Chan Kim, W. and Mauborgne, R. (1999), Creating New Market Space, Harvard Business Review, January-February 1999; Chan Kim, W. and Mauborgne, R. (1997), Value Innovation: The Strategic Logic of High Growth, Harvard Business Review, January-February 1997}

³ “Strategic Management” by Shepard, Saloner, Podolny, 2001

⁴ Chris Zook, “Beyond the Core”, Harvard Business School Publishing, 2004.

⁵ Pine, J. and Gilmore, J. “Experience Economy”, Harvard Business School Press, Boston, 1999.

⁶ Geoffrey Miller, “Spent, Sex. Evolution, and consumer behavior,” May 2009, Viking Adult, ISBN 9781101047798

⁷ This is probably a better name describing on what is happening currently as compared to terms such as “service economy” or “knowledge based economy”. Problem with the concept of “Service Economy” is that it includes all services, ranging from maid service to nuclear energy management for entire nation. It leads to difficulty in assessing activities from different industries and countries to ascertain whether current “service policies” applied would lead to sustainability. Similarly, Knowledge based economy (KBE), though rightly points to “importance of knowledge” in value creation and sustainability, yet “knowledge” alone is not enough while deciding on where to focus for policy decisions.

1-8. (canceled)

9. An integrated strategic positioning tool or “Happiness-Innovation Matrix Model, which deals holistically with firm's internal structure, its employees and its product development efforts as well as its interactions with those outside the firm, such as suppliers, interacting infrastructure and societal interaction space, which is focused to enhance firm's sustainability and competitiveness, for formulating product/product combinations/ service/ solution or their combinations and consists of:
Creating integrated strategic positioning tool (ISP tool), comprising of 3 influencing poles (pillars of influence) providing interactions viz. product interactions, infrastructure interactions and societal interactions which make solutions more potent; 4 circular categories (circle of happiness) which help firm to enhance value creators' contribution, whose enhancement value dependent on relative proximity to influencing poles, to product's success by effectively utilizing network externalities; overall combined strategic space is created by combination of 3 influencing poles and 4 circular categories whose value is measured in terms of happiness (combination of logical and emotional happiness minus disgust factor) in real or virtual world or combination thereof.

10. The method of claim 9, wherein longevity of happiness provided to user is achieved by satisfying innate over expressed needs (express need fulfillment gives short term happiness), extent of emotional and logical happiness fulfillment which is provided by self-indulgent and/or societal happiness minus disgust factor (in terms of self-focus and societal focus happiness).

11. The method of claim 9, wherein product projects persona as well as a means for delivery of information/product for consumption and product interactions makes product combination more responsive to individuals' requirements.

12. The method of claim 9, wherein infrastructure interactions provides backup to product and enhances “Wholesome experience”, by making combination relevant, responsive (fast), seamless, exclusive based on formatting, location and time specific, providing interactivity between products or even allowing access to venue to social interaction; and the method of claim 9, wherein societal interactions leverages on Virtual/Real Space for Social bonding & trustworthy knowledge/problem resolution and interactions.

13. The method of claim 9, wherein 4 circular categories enhancing value creators' contributors comprising of open system/platform, closed system/platform, democratized participants and firm's own employees which provide “Value Creator factors” for enhancing consumer happiness and “Network Externality factors” affecting product/firms sustainability.

14. The method of claim 9, wherein overall combined strategic space, created by combination of 3 influencing poles and 4 circular categories forms 3 broader areas—area formed between product interaction and infrastructure interaction influencing pole where products communicate with each other to formulate a consumer specific “service offer” or provide location specific response from centralized communication; area formed between product interaction and societal interaction influencing pole where products leverages on knowledge gained from individual's interactions within a Society and thus either they leverage on Knowledge gained from “communication within the societies” to make requirement specific “service offer” or create business based on people's actions and interactions; and area formed between infrastructure interaction and societal interaction influencing pole where products are made more relevant by leveraging on “location and/or format based societies” and matching it with individual's location and/or format used and can be innate need specific. The overall combined strategic space enables users to see industry's overall competitive battle plan, strategize and act accordingly.

15. The method of claim 9, wherein numerical value can be given to overall combined strategic space covered by the product/ product combinations/service/solution or their combinations offer, giving overall happiness value, which can be calculated by creating Consumer Needs Map (CNM) whereby specific numeric factor values are given to different locations on the map. The relative numeric values assigned to various factors remain dynamic, reflecting their changing potency to give happiness which keeps changing with industry cycle and maturity.

16. The method of claim 9, wherein Integrated strategic positioning tool (ISP tool) can also be adopted to construct Social stability Map (SSM) which will help to strategize, formulate and implement method for creating happy and stable society for social coherence and stability. In this form 3 influencing poles providing interactions remains the same while 4 circular categories change, being Empowerment of Firms (for National Competitiveness), Empowerment of Value Creators (for National Development), National Governments and international treaties (for Sovereignty) and Empowerment of Global Forces (for participating in Global Economy). By analyzing the stability/disruptive effect of various factors, as given in this model, various decisions can be formulated.
